(19) United States
(12) Patent Application Publication
(10) Pub. No.: US 2004/0064314 A1
(43) Pub. Date: Apr. 1, 2004

(54) Methods and apparatus for speech end-point detection

(76) Inventors: Nicolas de Saint Aubert, Massy (FR); David Kryze, Santa Barbara, CA (US)

Correspondence Address: Gregory A. Stobbs and Alan L. Cassel, Harness, Dickey & Pierce, P.L.C., P.O. Box 828, Bloomfield Hills, MI, 48303, US

(21) Appl. No.: 10/259,131

(22) Filed: Sep. 27, 2002

(51) Int. Cl. G10L 15/20

(52) U.S. Cl. 704/233

(57) ABSTRACT

In one aspect, the present invention provides a method for detecting speech end points in an input signal containing speech portions and non-speech (noise) portions. The method includes processing signal frames of a digital input signal containing speech and non-speech portions to extract features from the signal frames, comparing at least one property of the processed signal frames to a noise model and a speech model to determine whether a processed signal frame contains speech or noise, generating a signal indicative of the speech or noise determination, and updating either the speech model or the noise model depending upon whether a processed signal frame is determined to contain speech or noise, respectively. In some configurations, the method also includes resetting the speech and noise models dependent upon whether a number of zero crossings in a determined inter-frame correlation is greater than a threshold number.

### FIELD OF THE INVENTION

The present invention relates generally to automatic speech recognition and speech processing systems. More particularly, the invention relates to an end-point detection system for use in automatic speech recognition and speech processing systems.

### BACKGROUND OF THE INVENTION

Speech endpoint detection is important for the front end processing of speech recognition systems. At least some known end-point detectors used in speech recognition and other audio processing systems are based on energy measurements and require different threshold settings for different environmental conditions. To perform satisfactorily, noise processed by these end point detector must not undergo significant change in level and/or quality or nature as the end point detector is being used because the estimate of the noise used by the detector is made from a small segment taken from the beginning of the audio stream. When the signal-to-noise ratio of the speech or audio changes significantly or approaches zero, or when multiple speech sources are present, these end point detectors will fail to operate satisfactorily.

### SUMMARY OF THE INVENTION

Various configurations of the present invention address this problem by taking a different approach. Some end-point detection system configurations of the present invention employ a dissimilarity measure in the spectrum domain to accurately distinguish a speech pattern from a noise pattern, without requiring thresholding. Some configurations utilize Gaussian models for speech and noise. The Gaussian models are adapted on the fly to take into account environmental changes, ensuring that the end point detection configuration will trigger correctly, irrespective of the signal-to-noise ratio. Some configurations of the present invention are based on plural units working in parallel in order to offer the highest robustness with respect to the dynamic levels of speech and noise.

In the event a plurality of speech sources are present at the same time, some configurations of the present invention utilize an energy level detector and speech tracking system, which make it possible to track only the speech portions associated with a given person, such as portions of speech within a certain power range.

In addition to employing separate speech and noise models, some configurations of the present invention also include a module that performs self-correction whenever the speech and noise models happen to become inaccurate after an incorrect initial estimation, or upon a sudden environmental change. Some configurations employ a blind algorithm based on inter-frame correlation that automatically resets estimators and starts a new adaptation while discarding the corrupted speech and noise models, thereby allowing the end point detector to construct new models. At least some configurations of the present invention are thus able to react to and correct for any deadlock that occurs and to recover from a bad initialization period.

Therefore, various configurations of the present invention provide a method for detecting speech end points in an input signal containing speech portions and non-speech (noise) portions. The method includes processing signal frames of a digital input signal containing speech and non-speech portions to extract features from the signal frames, comparing at least one property of the processed signal frames to a noise model and a speech model to determine whether a processed signal frame contains speech or noise, generating a signal indicative of the speech or noise determination, and updating either the speech model or the noise model depending upon whether a processed signal frame is determined to contain speech or noise, respectively.

In another aspect, various configurations of the present invention provide a method for detecting speech end points in an input signal containing speech portions and non-speech (noise) portions. This method includes analyzing signal frames of the input signal to generate a noise model if no noise model exists. When a noise model exists, the method also includes determining, frame by frame, whether a frame contains speech or noise and generating a signal indicative of whether the frame contains speech or noise; and when a specified number of consecutive speech frame determinations have been made, resetting a speech model and the noise model dependent upon a comparison of an inter-frame correlation property with at least one selected criterion.

In yet another aspect, various configurations of the present invention provide an apparatus for detecting speech end points in an input signal containing speech portions and non-speech (noise) portions. This apparatus is configured to process signal frames of a digital input signal containing speech and non-speech portions to extract features from the signal frames, compare at least one property of the processed signal frames to a noise model and a speech model to determine whether a processed signal frame contains speech or noise, generate a signal indicative of the speech or noise determination, and update either the speech model or the noise model depending upon whether a processed signal frame is determined to contain speech or noise, respectively.

In still another aspect, various configurations of the present invention provide an apparatus for detecting speech end points in an input signal containing speech portions and non-speech (noise) portions. This apparatus is configured to analyze signal frames of the input signal to generate a noise model if no noise model exists. When a noise model exists, the apparatus is configured to determine, frame by frame, whether a frame contains speech or noise and generate a signal indicative of whether the frame contains speech or noise, and when a specified number of consecutive speech frame determinations have been made, reset a speech model and the noise model dependent upon a comparison of an inter-frame correlation property with at least one selected criterion.

In another aspect, various configurations of the present invention provide a machine readable medium having recorded thereon instructions configured to instruct a processor to detect speech end points in an input signal containing speech portions and non-speech (noise) portions. The instructions are configured to instruct the processor to process signal frames of a digital input signal containing speech and non-speech portions to extract features from the input signal, compare at least one property of the processed signal frames to a noise model and a speech model to determine whether a processed signal frame contains speech or noise, generate a signal indicative of the speech or noise determination, and update either the speech model or the noise model depending upon whether a processed signal frame is determined to contain speech or noise, respectively.

In yet another aspect, various configurations of the present invention provide a machine readable medium having recorded thereon instructions configured to instruct a processor to detect speech end points in an input signal containing speech portions and non-speech (noise) portions. The instructions are configured to instruct the processor to analyze signal frames of the input signal to generate a noise model if no noise model exists. When a noise model exists, the instructions are configured to instruct the processor to determine, frame by frame, whether a frame contains speech or noise and to generate a signal indicative of whether the frame contains speech or noise, and when a specified number of consecutive speech frame determinations have been made, reset a speech model and the noise model dependent upon a comparison of an inter-frame correlation property with at least one selected criterion.

Various configurations of the present invention will thus be appreciated to offer high robustness with respect to dynamic levels of speech and noise, and resistance to changes in environmental conditions such as signal to noise ratio. Various configurations of the present invention will also be appreciated to provide resistance to poor initialization conditions and better tracking of a single speech source in the presence of several speech sources.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a high-level block diagram representative of various configurations of an end-point detection system of the present invention.

FIG. 2 is a detailed block diagram of an end point detection system configuration consistent with FIG. 1.

FIG. 3 is a graph of a typical inter-frame correlation signal associated with speech.

FIG. 4 is a graph of a typical inter-frame correlation signal associated with noise.

FIG. 5 is a graph illustrating Gaussian distributions of speech and noise models, illustrating how speech and noise are discriminated using a dissimilarity measure.

FIG. 6 is a block diagram representative of some configurations of an end point detection apparatus of the present invention.

### DETAILED DESCRIPTION OF THE PREFERRED EMBODIMENTS

The following description of the presently preferred embodiment(s) is merely exemplary in nature and is in no way intended to limit the invention, its application, or uses.

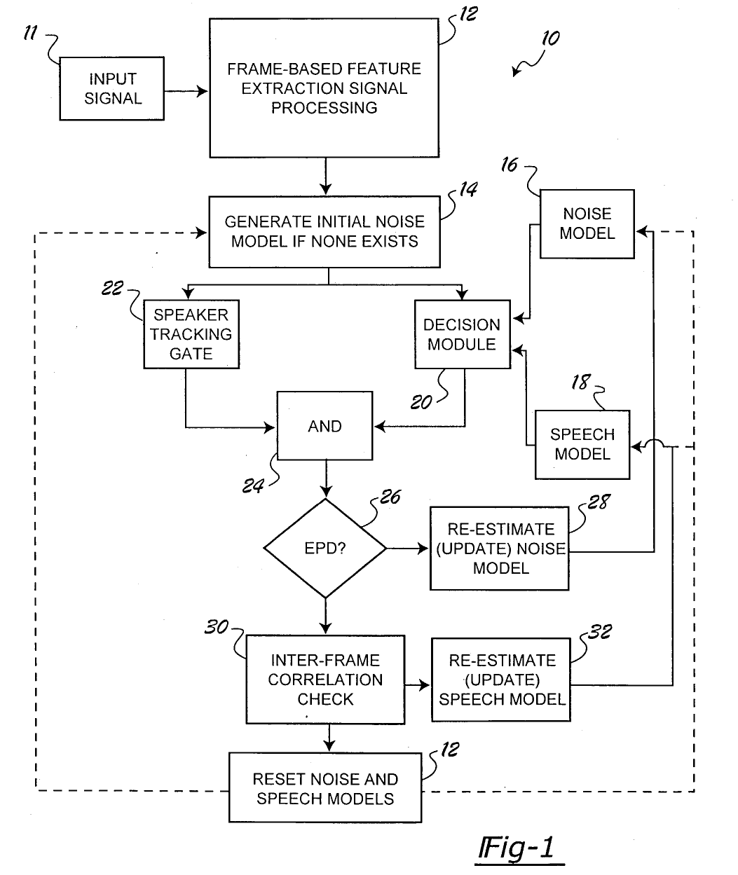

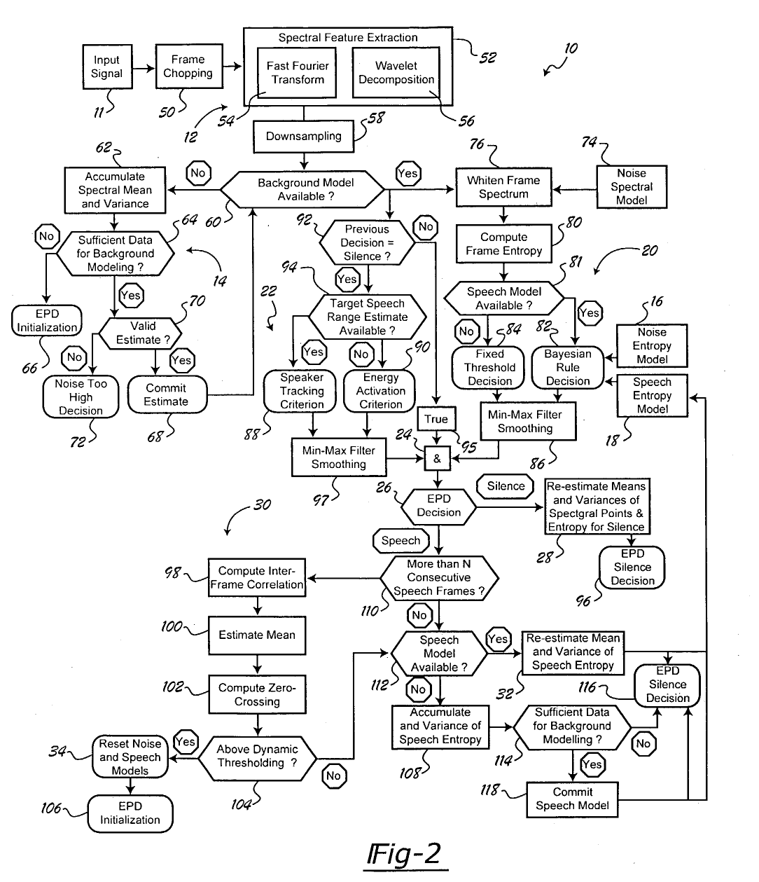

FIGS. 1 and 2 show the presently preferred end-point detection system in two different levels of detail. FIG. 1 is a high level block diagram of the end-point detector and FIG. 2 is a more detailed block diagram of the detector.

In some configurations of the present invention and referring to FIGS. 1 and 2, an input speech signal is applied at 11. Although not shown in FIG. 1 or 2, the input speech signal in some configurations has already been digitized utilizing a suitable analog to digital converter. The input signal is fed into a signal processing block 12, which, in the illustrated configuration, chops 50 a digitized input signal into frames of a suitable size (for example, 20 ms, with a chopping interval 10 ms to allow an overlap between adjacent frames in some configurations). At least one configuration operates on these individual frames as they occur consecutively in the input signal. The input signal is also processed to extract spectral features 52. This may be accomplished, as illustrated more fully in FIG. 2, by performing fast fourier transform 54 and/or wavelet decomposition 56 processes on the digital data.

After being processed, the consecutive frames of input signal are fed to an initialization module 14 which performs a system initialization, if needed. More specifically, various configurations of the present invention employ two statistical models: a noise entropy model 16 and a speech entropy model 18. Initialization module 14 generates an initial noise model to populate noise entropy model 16 with initial noise model data, if such model does not already exist. Thus module 14 creates an initial noise entropy model 16 and thereafter monitors the operation of end point detector system 10 to remember whether a noise model currently exists. The configurations represented by FIG. 1 use module 14 to generate only the spectral model of the noise, and three statistical models are actually used: the noise spectrum 74 (used to whiten the frame for entropy determinations), the noise entropy 16, and the speech entropy 18 (all of which are assumed to be Gaussian). Before computing an entropy measure, a good estimate of a “whitening spectral model” is obtained, and this task is performed by module 14 of FIG. 2.

(In some configurations, entropy is determined without whitening. In these configurations, module 14 is used to compute noise power for SNR estimation, or for ensuring that noise power does not exceed a specified threshold, for example, a “too soon” or a “too loud” threshold, wherein the speaker spoke during background estimation, or the noise is too loud for proper operation.)

For configurations represented by FIG. 1, entropy measures are determined immediately and speech and noise models are determined in parallel, as there is no requirement to build a noise model before building a speech model. An initial thresholding is done on a fixed basis, and when Gaussian models are populated, a likelihood ratio is used. Representing an input spectral feature vector as S and a noise spectral model vector as N, a normalized inverse entropy E is determined in various configurations of the present invention using a relationship written as:

$$\begin{matrix} E = \frac{{\sum }_{i = 1}^{n} P ( i ) * log ( P ( i ) )}{log ( n )} + 1 ; \\ where : \\ P ( i ) = \frac{S ( i )}{{\sum }_{j = 1}^{n} S ( j )} without whitening , or \\ P ( i ) = \frac{S ( i ) / N ( i )}{{\sum }_{j = 1}^{n} S ( j ) / N ( j )} with whitening ,\end{matrix}$$

and n is the dimension of the spectral feature space.

Incoming frames of the input signal are fed to two parallel processing branches. The first branch comprises a decision module 20, and the second branch comprises speaker tracking gating module 22. An output of decision module 20 and an output of speaker tracking gating module 22 are combined to effectively produce a single Boolean output. In various configurations, this combination is effected by the outputs into an AND gate 24 or circuitry which produces a logically equivalent result. Speaker tracking gating module 22 uses a speaker tracking module 88 in conjunction with an energy activation module 90 to gate the results of decision module 20 on and off, depending on whether end point detector system 10 concludes that speech has commenced. This gating function thus makes the results of decision module 20 active when speech is determined to have started. As will be more fully explained in connection with FIG. 2, this gating decision is made either on the basis of actual speaker tracking, using a speaker tracking algorithm, or on the basis that the energy within the signal frame meets a predetermined energy activation criterion.

Decision module 20 preferably employs a Bayesian processing function whereby noise entropy model 16 and speech entropy model 18 are each compared to the incoming frame. In some configurations, this comparison is performed in the entropy domain. Thus, spectral features generated by module 12 are used to compute frame entropy and the computed entropy value is then compared with the noise entropy and speech entropy data stored in the respective entropy models 16 and 18. More specifically, model 16 represents a prior probability distribution pₙ(θ) for entropy of noise signals, and model 18 represents a prior probability distribution pₛ(θ) for entropy of speech signals. Bayes theorem is applied to merge the entropy data from the current frame with each model 16, 18 to produce posterior distributions, and the resulting posterior distributions from each model 16, 18 are analyzed to determine whether the current frame is more likely to be a noise frame or a speech frame. The Bayes theorem is used to relate the ratio of the posterior probabilities written as:

$$\frac{p ( speech \vert observed frame )}{p ( noise \vert observed frame )}$$

to the ratio of the likelihoods written as:

$$\frac{log ( p ( observed frame \vert speech ) )}{log ( p ( observed frame \vert noise ) )} ,$$

discarding terms coming from the priors and the normalizing factors for the sake of simplicity. With Gaussian probabilities, the relationship written as:

log(P(observed frame|speech))>log(P(observed frame|noise))

is simplified as follows:

$$\frac{{( E - M ( n ) )}^{2}}{V ( n )} - \frac{{( E - M ( s ) )}^{2}}{V ( s )} + log ( V ( n ) / V ( s ) ) > 0 ,$$

where:

E is the current frame entropy;

M(n) is the mean of the noise;

M(s) is the mean of the speech;

V(n) is the variance of the noise (entropy);

V(s) is the variance of the speech (entropy).

The output of AND gate 24 is fed to end-point decision logic 26, which determines whether the current frame contains speech or silence. (As used herein, “silence” refers to the absence of speech. “Silence” may, and in general, does include residual background noise, even when speech is not present.) If the determination made by module 26 is that the current frame represents silence, then re-estimation module 28 re-estimates numerical parameters associated with noise entropy model 16 and the re-estimated parameters are stored in noise entropy model 16. Noise entropy model 16 is thus updated with current noise level parameters. In addition, noise spectral model 74 is also reestimated. When the background noise remains relatively unchanged from frame to frame, re-estimation module 28 produces very little change in noise entropy model 16. On the other hand, when the noise level changes over time (as might be experienced, for example, in a moving vehicle driving on an uneven road surface), re-estimation module 28 is likely to produce more frequent revisions of noise entropy model 16.

If end-point detection logic 26 determines that an input frame represents speech, then a checking operation is performed by checking module 30. Module 30 performs an inter-frame correlation. If a comparison of an inter-frame correlation property with at least one selected criterion indicates that what to determine whether the spectral feature data of the current frame is well correlated to the spectral feature data of preceding frames. If the correlation from frame to frame is sufficiently high (i.e., the spectral features do not change significantly from frame to frame) then module 30 will infer that the current frame represents speech, in which case, speech entropy model 18 is updated by re-estimation module 32.

If checking module 30 does not find a high correlation between the current frame and preceding frames, then module 30 infers that the current frame, which had been presumed to be speech, actually represents noise. For example, this inference would occur if end point detection system 10 began tracking speech immediately upon startup and inferred, incorrectly, that the speech was noise. In this case, end point detection system 10 would update the noise model using speech data and also would update the speech model using noise data. Reset module 34 is provided to prevent these incorrect updates from occurring. In some configurations, reset module 34 resets the noise model and speech model by discarding the model data preserved in each, thereby placing end point detection system 10 in a state in which initialization module 14 generates a new noise model during subsequented frame processing.

End-point detection system 10 thus maintains separate, continuously updated models of both noise and speech. A reset function, based on inter-frame correlation, corrects for erroneous inversion of the noise and speech models that might otherwise occur when speech is present within the first frames upon system startup.

FIG. 2 shows a block diagram representative of various configurations of the present invention in greater detail than is shown in FIG. 1. Where applicable, reference numerals of like components from FIG. 1 are used to represent corresponding components in FIG. 2. Referring to FIG. 2, input signal 11 is subdivided into frames by frame chopper 50. The subdivided frames are then processed by spectral feature extraction module 52. In various configurations, spectral feature extraction is performed by module 52 using a fast Fourier transform (FFT) module 54 and/or a wavelet decomposition module 56. In still other configurations, other types of feature extraction modules are used. Extracted features are then downsampled at 58 and thereafter distributed to the remainder of end point detection system 10. A logic function at 60 determines whether an existing noise model is already available. If so, the downsampled frames are processed by gating module 22 and by decision module 20, as is more fully described below.

If a noise model does not yet exist, logic function 60 routes the downsampled frames to initialization module 14. Initialization module 14 accumulates spectral mean and variance data based on the downsampled frame in module 62 and then makes a determination at 64 whether there is sufficient data for background (noise) modeling. For example, in some configurations, a preset threshold of 5 frames is used for this determination, and in some other configurations, a preset threshold of 10 frames is used. In the case of insufficient data, end point detection system 10 uses a preset end-point detection initialization noise model 66. Otherwise, end point detection system 10 computes such an estimate and commits to it at 68.

In some instances, the spectral mean and variance data may be inadequate for computing a noise model, as, for example, when the noise level is too high for making a meaningful background data model. A test is made for high noise level at 70, and if the noise level is too high for a valid model to be constructed, a branch is made to a state 72 that indicates that noise is too high for a meaningful discrimination to be made between speech and noise. Some configurations then notify the user that conditions are too noisy and that end-point detection system 10 may not be operating successfully. The threshold levels utilized by module 70 to make its determination can be empirically determined, and depend upon sound levels and external conditions (i.e., noise in the environment in which the audio signal is generated or recorded). In some configurations, the threshold levels are adjustable by the user.

The initial background noise model is loaded into noise entropy model 16 (more precisely, a data store for noise model 16) for subsequent use by decision module 20. In addition to noise entropy model 16, some configurations also maintain a second noise model, identified in FIG. 2 as noise spectral model 74. Whereas in some configurations, noise entropy model 16 stores mean and variance parameters from which a noise entropy Gaussian distribution may be specified, noise spectral model 74 stores actual noise spectral data extracted from the downsampled frame data (from downsampling module 58) during intervals that are determined to contain only background noise with no speech present. These noise spectral data are supplied to a frame spectrum whitening module 76 which operates upon the incoming downsampled frame data via data path 78. The frame spectrum whitening module 76 uses the noise spectral data from model 74 and adds the inverse of this data to the incoming downsampled frame data, effectively smoothing out peaks and valleys of the noise spectrum to make the background noise more closely resemble white noise (i.e., noise having equal energy at all frequencies of the spectrum). Spectrum whitening improves the reliability of end point detection system 10 by establishing a consistent spectral baseline to which the incoming downsampled frame data are constrained.

After whitening, the incoming frame data are supplied to an entropy computation module 80. Module 80 computes entropy value for the frame, based on the spectral features contained in the frame data. If a speech model is available 81, this computed entropy value is then processed using a Bayesian rule decision module 82 which performs a decision as to whether the current frame represents speech or noise based upon a comparison of at least one property of the processed signal frame. For example, the entropy of the processed signal frame is compared with a noise entropy model 16 and a speech entropy model 18 in the following manner. If no speech model is available, a fixed threshold decision module 84 is used, instead. Modules 82 and 84 produce binary outputs, representing speech or silence.

When end point detection system 10 is first initialized, there may be no speech entropy model data, as this data is accumulated while the system is being used. In such case, a fixed threshold decision module 84 is used to perform the decision whether the incoming frame represents speech or noise. The fixed threshold decision operates by comparing the frame entropy of the incoming frame with a predetermined threshold.

In general, the respective entropies of a speech signal and a noise signal are quite different. The speech signal is more ordered and thus has a lower entropy value; whereas the noise signal is more disordered and thus has a higher entropy value. Fixed threshold decision module 84 compares the entropy of the incoming frame with fixed threshold values representing a typical noise entropy and a typical speech entropy and thereby determines whether the incoming signal represents speech or noise.

As frames are processed by decision module 20 (either by the Bayesian rule decision module 82 or by fixed threshold decision module 84) the resultant decisions are accumulated and filtered in a max-min smoothing filter 86. This filter smoothes out any rapid fluctuations in the speech-noise decision signal to produce a speech-noise logic signal upon which end-point detection can be based. In this regard, it will be appreciated that end-point detection can be used not only to identify a transition between noise to speech, where the speech signal begins, but also the transition from speech to noise, where the speech signal ends. Thus end-point detection can be used to isolate the speech content within a data stream.

In some configurations, the filtering performed by modules 86 and 97 is identical. The binary decision fed into the module is first passed through a min filter of (for example) 5 taps, so that the output of m(t) of the filter at time t can be written as a simple function of the past boolean decision d(t) (=0 or 1):

m(t)=d(t) & d(t−1) & . . . & d(t−k), where k=5,

i.e., k is equal to the number of taps of the min filter, which is 5 in this example, but may be different in other configurations. The output of this filter is then fed into a maxmin filter of (for example) 15 taps, so that the output r(t) of this filter at time t can be written as a simple function of the past boolean input m(t) (=0 or 1)

r(t)=m(t)|m(t−1)| . . . |m(t−L), where L=15,

i.e., L is equal to the number of taps of the maxmin filter, which is 15 in this example, but may be different in other configurations. The global delay of the two stage filtering is (k+L)/2, which is 20 in this example.

Although not required in all implementations the presently preferred embodiment employs a speaker tracking gating system 22 that turns off or blanks the operation of decision module 20 when extraneous speech may be present in the input signal. Extraneous speech may be present, for example, where the main speaker, upon which the end-point detection system is intended to operate, is speaking in a room where there is other human conversation present. This could occur, in a conference atmosphere, where members of the audience are speaking to one another as the main speaker is giving his or her presentation. In such case, the extraneous speech should desirably be treated as background noise. However, because speech and random noise have significantly different entropy values, it is possible that the extraneous speech could be inadvertently used to decisions.

To remove this potentially undesirable effect, speaker tracking gating module 22 employs a speaker tracking algorithm at 88 and an energy activation algorithm at 90. Speaker tracking gating system 22 is designed to operate during those intervals where the system has detected (rightly or wrongly) that speech has just started. This is accomplished by first testing to determine if the previous decision represented the silence or background noise condition (as at 92). If the system detects that speech has now started as at 94, speaker tracking algorithm 88 is used. If speech has not started (i.e., the system has concluded that the signal still represents background noise only) then the energy activation algorithm 90 is used. (The determination of whether speech has started, for purposes of module 94, is not the same as the EPD (End Point Detection) decision at module 26. For example, in some configurations, the determination at module 94 is made by comparison to a sound level threshold that can be empirically adjusted by the user of end point detection system 10. In some configurations, different sound level thresholds may be provided for different frequencies.)

More specifically, some configurations utilize speaker tracking gating module 22 to validate only silence to speech transitions detected by module 20. Speaker tracking gating module 22 is not utilized otherwise in these configurations. In case the previous decision was that speech was present, the input on this side of and gate 24 is kept without any influence, i.e., it is set to TRUE 95. Block 94 can thus be considered as a block that determines whether a speech range estimate is available. After the first occurrence of a speech utterance, statistics, such as power range and other statistics, are extracted to condition the next silence to speech transition. If these statistics are not available (as, for example, just after system start), fixed thresholding is used.

Speaker tracking algorithm 88 may be realized utilizing a variety of different speaker tracking criteria designed to discriminate among plural speakers. The speaker tracking algorithm may discriminate among speakers based on such criteria as relative volume level or spectral frequency content, for example. The volume level criterion would discriminate among speakers, favoring the speaker who is loudest or closest to the microphone. The spectral feature criterion would discriminate among speakers based on the individual speaker's tonal qualities. Thus a male speaker and a female speaker could be discriminated based on pitch. Other discrimination techniques may also be used. For example, speakers who speak at different speech rates may exhibit different spectral features or spectral energies when viewed over a predetermined time interval. In some configurations, module 88 utilizes a speaker tracking algorithm that compares the energy of the frame with a specified sound level that can be adjusted by the user.

When speech has not yet started, energy activation module 90 produces a logic signal based upon an energy activation criterion. For example, energy activation module produces a logic signal indicative of whether the energy of the current frame is above or below a predetermined value.

Similarly to decision module 20, speaker tracking gating module 22 produces a logic signal that may fluctuate from frame to frame, depending on outputs of the respective speaker tracking or energy activation modules 88 and 90. Thus, a max-min smoothing filter 97 is employed that functions essentially in the same manner as filter 86. The output of filter 97 represents a logic signal that is applied to AND gate 24. The logic signal output from filter 97 thus gates the logic signal output from filter 86 on and off, so that the noise-speech decision is only engaged during appropriate conditions as determined by speaker tracking gating module 22.

If the output of filter 86 indicates that the incoming signal represents silence (non-speech), decision module 26 invokes re-estimation module 28, which outputs a end point decision of silence, i.e., a signal indicative of silence at 96 and also updates noise entropy model 16 and noise spectral model 74. On the other hand, if decision module 26 determines that speech is now present in the input signal, the process flow branches to perform an inter-frame correlation check.

Checking module 30 performs its function by comparing inter-frame correlation, for which a predetermined number of frames are needed. Thus, in various configurations of the present invention, the inter-frame correlation check comprises an initial determination of whether the accumulated data represents more than a predetermined number (N) of consecutive speech frames. When the number of speech frames is sufficient 110, an inter-frame correlation check is performed at module 98. In some configurations, the inter-frame correlation check 98 is performed by comparing the time-domain version of the current frame at least one previous frame of the N consecutive speech frames to generate a correlation value. Some configurations perform this comparison between the current frame and a second or third previous frame, rather than between the current frame and the frame immediately preceding the current frame. The correlation value is accumulated with previous values and a mean is estimated at module 100. This mean serves as a baseline against which the correlation values are compared. In some configurations, the number N of speech frames considered sufficient by module 110 is a variable that can be adjusted empirically by the user for best performance.

In some configurations, interframe correlation is determined as the first lag of the correlation between a process emitting only the spectral feature vector S(t) at time t and a process corresponding to the current emission of spectral features delayed in time by 2 frames. Thus, for example, if S(t) is the spectral feature vector (spectral frame) coming at time t, the two involved processes are X(n)=S(t), for any given time n, and Y(n)=S(n−2), for any given time n. The correlation is determined for three other frames, so that:

$$\begin{matrix}X = \{ S ( t ) , S ( t ) , S ( t ) \} , \\ Y = ( S ( t - 4 ) , S ( t - 3 ) , S ( t - 2 ) \} , and \\ {C}_{XY} ( 0 ) = E [ X ( n ) Y ( n ) ] = \frac{1}{3} \cdot S ( t ) \cdot {\sum }_{j = 2}^{4} S ( t - j ) .\end{matrix}$$

By introducing the vector

$$P ( t ) = {\sum }_{j = 2}^{4} S ( t - j ) ,$$

and normalizing the correlation between 0 and 1 using the Cauchy-Schwartz inequality, a “correlation factor” written as follows is determined:

$$C = \frac{{\vert S \cdot P \vert}^{2}}{\vert S \cdot S \vert * \vert P \cdot P \vert} .$$

Some configurations of the present invention compute a running average of the correlation factor using a decaying factor, using, for example, a relationship written as:

mean(t+1)=α*mean(t)+(1−α)*C(t), where α˜0.97

The estimated mean is subtracted from the correlation factor to obtain a normalized value, which is examined for variations. (In various configurations, the variance and the mean have already been normalized.) This examination is performed using a standard zero crossing technique.

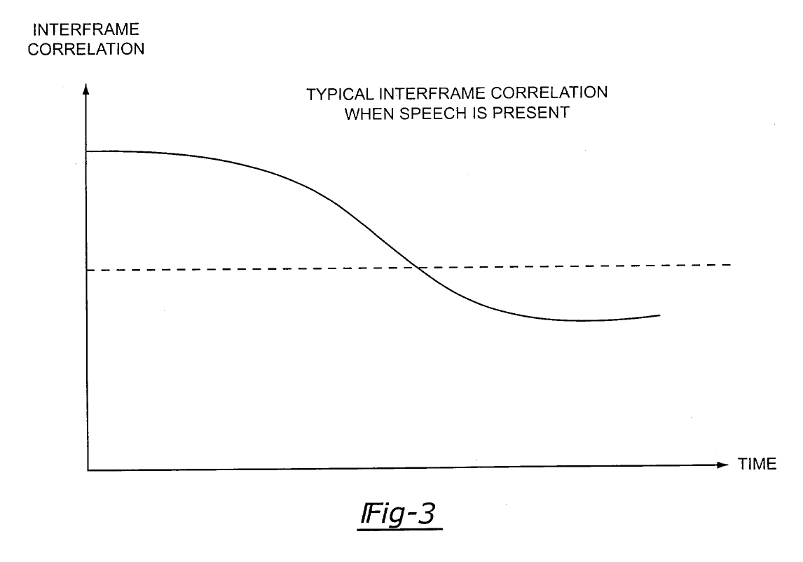

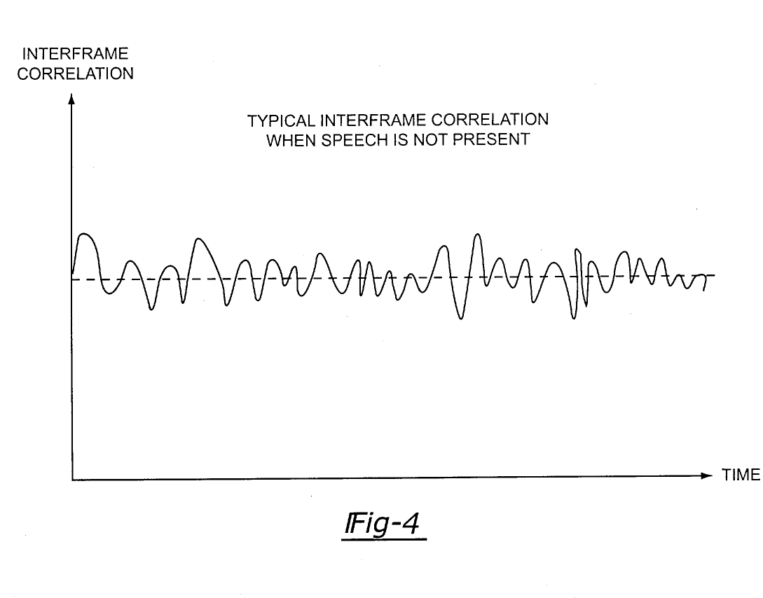

In module 102, a comparison of an inter-frame correlation property with at least one selected criterion is made to determine whether to reset speech model 18 and noise model 16 and 74. More specifically, in some configurations, the inter-frame correlation data is compared with the baseline mean to determine whether the correlation data waveform has crossed the mean baseline, i.e., whether a “zero-crossing” has occurred. The inter-frame correlation value of a speech signal typically crosses the mean baseline relatively infrequently, usually when the speech signal makes a transition from vowel to consonant. In contrast, background noise will typically fluctuate randomly, crossing the mean baseline numerous times during the same amount of time. A comparison of the speech and noise intercorrelation waveforms is presented by FIG. 3 and FIG. 4, wherein FIG. 3 is a graph of a typical inter-frame correlation signal associated with speech and FIG. 4 is a graph of a typical inter-frame correlation signal associated with noise. In some configurations, zero crossings are determined utilizing a “normalized” interframe correlation, in which a running average of the correlation is determined and removed from the current value to obtain a process with zero mean, making analysis of the zero crossings a simple way to estimate the speed of the correlation function.

The number of zero crossings is occurring within an interval is assessed in module 104. If the number of zero crossings corresponds to a pattern indicative of a noise signal, then inter-frame correlation checking module 30 concludes that the “speech” signal being processed is actually noise (no speech). Having made this determination, the noise and speech models are reset at 34 and a flag is set at 106 to indicate that end-point detection system 10 is in an initialization state. In the initialization state, initialization module 14 is employed to generate an initial noise model.

If the decision at 104 is that the incoming signal represents speech, then the mean and variance of the speech entropy model are updated by module 32. A check 112 is then made to determine whether a speech model is available. If no speech model has yet been created, module 108 accumulates mean and variance speech entropy data until a sufficient quantity is accumulated to generate a speech model. If there is not sufficient data, module 114 generates a decision 116 indicating that the current frame is a speech frame, i.e., it generates a signal indicative of a speech determination. Otherwise, there is sufficient data, and module 118 commits the model as speech entropy model 18 and generates a decision 116 indicating that the current frame is a speech frame.

In some configurations, module 104 uses a adaptative thresholding technique designed to measure the time spent by a discrete process in the top of a curve. Let Z(t) denote the evolution of the number of zero crossings in time; let Z_{trigger}, Z_{margin}, and Z_{maxcount} be three fixed threshold values (e.g., 25, 3, and 10, respectively); and let α be a smoothing factor for computing running averages (for example, 0.97). A threshold Z_{threshold} for Z(t) is initialized with Z_{trigger}−Z_{margin}, and is updated according to a formula written:

Z_{threshold}=max(Z_{trigger}−Z_{margin},max(Z(t)−Z_{margin}, Z_{threshold}*α)).

If Z(t) is above this threshold more than Z_{maxcount} consecutive times (t, t+1 . . . t+Z_{maxcount}), the target condition is met.

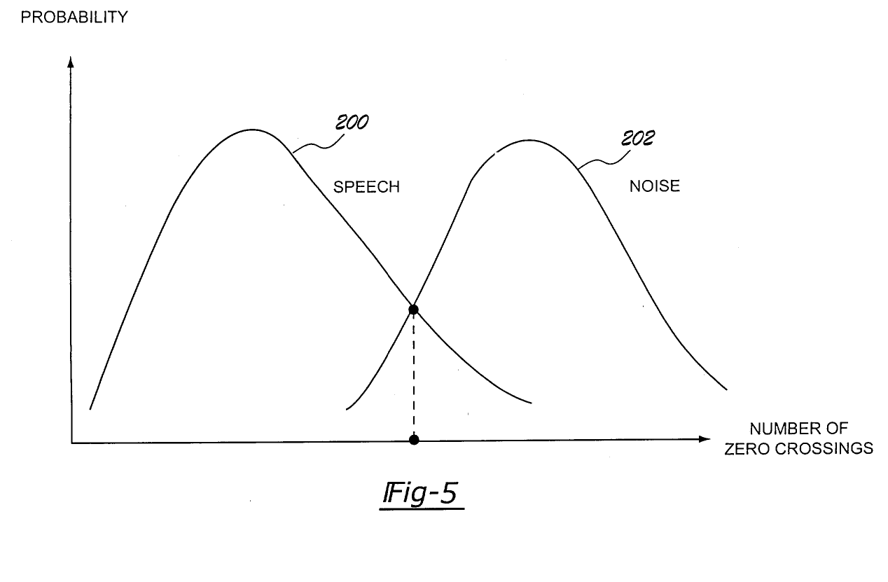

In contrast to conventional prior art end-point detection systems that utilize thresholding, various configurations of end-point detection systems 10 of the present invention discriminate between speech and individual Gaussian models such as those represented in FIG. 5. Gaussian curve 200 is associated with speech and Gaussian curve 204 is associated with noise. The intersection point E_{threshold} at 204 represents a point at which end-point detection system 10 considers it equally likely that the incoming frame is speech or noise. More particularly, an entropy less than E_{threshold} 204 is indicative of a frame in which speech is more likely than noise, and an entropy greater than E_{threshold} is indicative of a frame in which noise is more likely than speech. Note that threshold value E_{threshold} is not fixed, but rather will shift as the Gaussian speech and noise models are continuously updated.

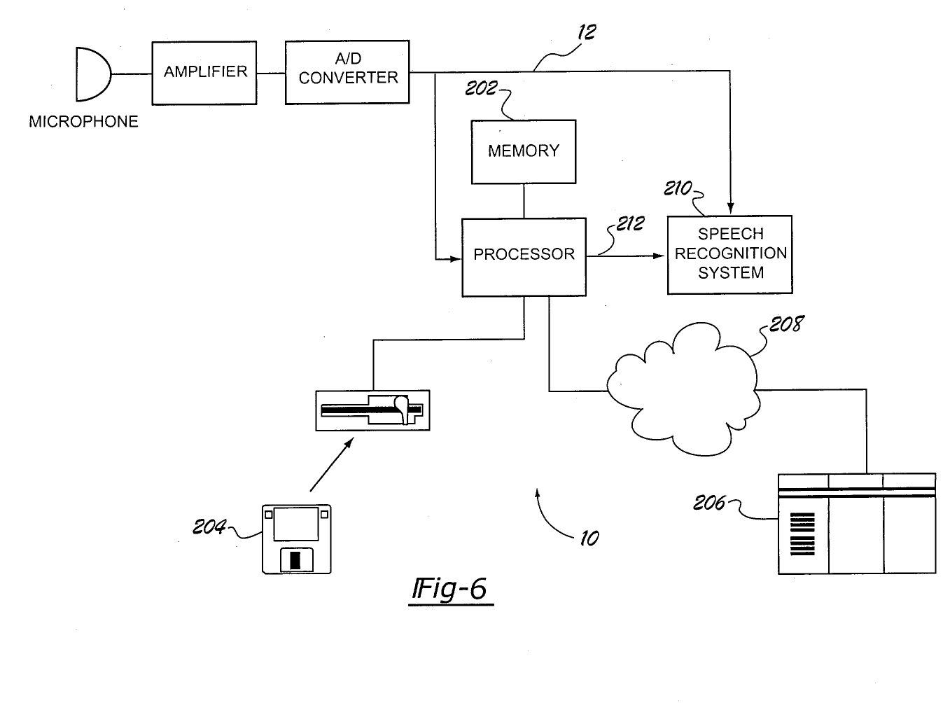

In some configurations and referring to FIG. 6, end point detection system 10 is implemented utilizing one or more general purpose processors or microprocessors 200, configured to process machine-readable instructions stored in a memory 202 (such as random access memory or read only memory contained with processor(s) 200) that instruct processor(s) 200 to perform the instructions described above and represented in FIGS. 1 and 2. Some configurations may access these machine-readable instructions via removable or fixed media 204 such as one or more floppy disks, hard disks, CD-ROMs, DVDs, or combinations thereof, or even on media from a remote location 206 via a suitable network 208. In other configurations not shown, one or more digital signal processing components, either programmable, pre-programmed, or configured for the purpose are utilized in place of, or in conjunction with, general purpose processors 200. End point detection system 10 is particularly useful when used in conjunction with speech recognition systems 210. In some configurations, speech recognition system 210 shares some or all of the same hardware used by end point detection system 10, or may comprise additional instructions in memory 202 and/or additional machine-readable instructions on media 204 or accessible via network 208. In particular, end point detection system configurations 10 are useful in providing information (for example, a signal 212 representative of a speech/noise decision) to speech recognition systems 210 to discriminate between speech utterances that are to be translated into text and noise that is to be ignored rather than translated. Various configurations of end point detection systems 10 are particularly useful when multiple speakers are present and/or when noise levels or characteristics are subject to variation as a function of time.

Unless otherwise indicated, a “medium having recorded thereon instructions configured to instruct a processor” to do something is not intended to be restricted to a single physical object, such as, for example, a single floppy diskette, magnetic tape, CD-ROM, DVD, ROM memory cartridge, or other form of ROM or RAM, but rather is intended to include embodiments in which the instructions are recorded on one or more physical objects, such as, for example, a plurality of floppy diskettes or CD-ROMs or combinations thereof. In addition, the medium having instructions recorded thereon is not intended to be limited to removable media, but is intended to include non-removable media such as, for example, a hard drive or a ROM fixed in a memory of a processor. Nor is it intended that the location or means of access to the medium be restricted, i.e., it is contemplated that the media may either be local to the processor or accessible via a wired or wireless network. In addition, the term “processor” as used below is intended to encompass any programmable electronic device capable of processing signals, including mainframes, microprocessors, and signal processing components, whether made up of discrete components or integrated on a single semiconductor chip or wafer.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for detecting speech end points in an input signal containing speech portions and non-speech (noise) portions, said method comprising:
processing signal frames of a digital input signal containing speech and non-speech portions to extract features therefrom;
comparing at least one property of the processed signal frames to a noise model and a speech model to determine whether a processed signal frame contains speech or noise;
generating a signal indicative of the speech or noise determination; and
updating either the speech model or the noise model depending upon whether a processed signal frame is determined to contain speech or noise, respectively.

2. A method in accordance with claim 1 further comprising:
determining when the comparisons indicate that a selected number of consecutive speech-containing frames have occurred;
determining an inter-frame correlation of the current frame with another previously received frame of the consecutively indicated speech-containing frames; and
resetting the speech and noise models dependent upon whether a number of zero crossings in the determined inter-frame correlation is greater than a threshold number.

3. A method in accordance with claim 1 further comprising, for a current frame immediately following a determination that the immediately previous frame contained noise:
comparing a signal level of the current frame to one or more sound level thresholds; and
gating said signal indicative of said speech or noise determination upon said signal to sound level threshold comparison.

4. A method in accordance with claim 1 wherein said noise model is a noise entropy model, and said speech model is a speech entropy model.

5. A method in accordance with claim 4 further comprising analyzing signal frames to update the noise entropy model and the speech entropy model.

6. A method in accordance with claim 1 wherein said at least one property of the processed signal frame is entropy of the processed signal frame, and further comprising conditioning said comparing at least one property of the processed signal frames to a noise model and a speech model upon the availability of a speech model, and if a speech model is not available, determining whether a processed signal frame contains speech or noise dependent upon a comparison of the entropy of the current frame against a fixed threshold.

7. A method in accordance with claim 1 and further comprising whitening a spectrum of the current frame in accordance with a noise spectral model prior to said comparing at least one property of the processed signal frames to a noise model and a speech model.

8. A method in accordance with claim 7 further comprising analyzing the signal frames to update the noise spectral model.

9. A method in accordance with claim 1 wherein said processing the signal frames comprises performing a fast Fourier transform.

10. A method in accordance with claim 1 wherein said processing the signal frames comprises performing a wavelet decomposition.

11. A method in accordance with claim 1 further comprising utilizing said signal indicative of the speech or noise determination in a speech recognition system to distinguish between speech utterances that are to be ignored from those that are to be translated into text by the speech recognition system.

12. A method for detecting speech end points in an input signal containing speech portions and non-speech (noise) portions, said method comprising:
analyzing signal frames of the input signal to generate a noise model if no noise model exists;
when a noise model exists, determining, frame by frame, whether a frame contains speech or noise and generating a signal indicative of whether the frame contains speech or noise; and
when a specified number of consecutive speech frame determinations have been made, resetting a speech model and the noise model dependent upon a comparison of an inter-frame correlation property with at least one selected criterion.

13. A method in accordance with claim 12 wherein said at least one selected criterion comprises zero crossings of the inter-frame correlation.

14. A method in accordance with claim 12 further comprising, when a noise model exists, updating, frame by frame, either the speech model or the noise model, depending upon whether a frame has been determined to contain speech or noise, respectively.

15. A method in accordance with claim 14 wherein said speech model comprises a speech entropy model and wherein said noise model comprises a noise entropy model.

16. A method in accordance with claim 15 wherein said noise model further comprises a noise spectral model.

17. A method in accordance with claim 16 wherein said at least one selected criterion comprises zero crossings of the inter-frame correlation.

18. A method in accordance with claim 12 wherein said determining, frame by frame, whether a frame contains speech or noise further comprises:
determining, frame by frame, whether a sound level is exceeded and either tracking a speaker according to a speaker tracking criterion or applying an energy activation criterion in accordance with said determination of whether a sound level is exceeded, and utilizing said tracking or said applying an energy activation criterion to produce a first gating decision.

19. A method in accordance with claim 18 further comprising determining, frame by frame, whether a speech model is available, and applying either a Bayesian rule decision utilizing a noise entropy model and a speech entropy model or a fixed threshold decision in accordance with said determination of whether a speech model is available, and to produce a second gating decision utilizing said Bayesian rule decision or said fixed threshold decision.

20. A method in accordance with claim 19 wherein said determining, frame by frame, whether a frame contains speech or noise further comprises determining both said first gating decision and said second gating decision are indicative of speech being present.

21. A method in accordance with claim 12 further comprising determining, frame by frame, whether a speech model is available, and applying either a Bayesian rule decision utilizing a noise entropy model and a speech entropy model or a fixed threshold decision in accordance with said determination of whether a speech model is available, said Bayesian rule decision or said fixed threshold decision thereby producing a gating decision.

22. A method in accordance with claim 12 further comprising utilizing said signal indicative of whether a frame contains speech or noise in a speech recognition system to distinguish between speech utterances that are to be ignored from those that are to be translated into text by the speech recognition system.

23. An apparatus for detecting speech end points in an input signal containing speech portions and non-speech (noise) portions, said apparatus configured to:
process signal frames of a digital input signal containing speech and non-speech portions to extract features therefrom;
compare at least one property of the processed signal frames to a noise model and a speech model to determine whether a processed signal frame contains speech or noise;
generate a signal indicative of the speech or noise determination; and
update either the speech model or the noise model depending upon whether a processed signal frame is determined to contain speech or noise, respectively.

24. An apparatus in accordance with claim 23 further configured to:
determine when the comparisons indicate that a selected number of consecutive speech-containing frames have occurred;
determine an inter-frame correlation of the current frame with another previously received frame of the consecutively indicated speech-containing frames; and
reset the speech and noise models dependent upon whether a number of zero crossings in the determined inter-frame correlation is greater than a threshold number.

25. An apparatus in accordance with claim 23 further configured to, for a current frame immediately following a determination that the immediately previous frame contained noise:
compare a signal level of the current frame to one or more sound level thresholds; and
gate said signal indicative of said speech or noise determination upon said signal to sound level threshold comparison.

26. An apparatus in accordance with claim 23 wherein said noise model is a noise entropy model, and said speech model is a speech entropy model.

27. An apparatus in accordance with claim 26 further configured to analyze signal frames to update the noise entropy model and the speech entropy model.

28. An apparatus in accordance with claim 23 wherein said at least one property of the processed signal frame is entropy of the processed signal frame, and wherein said apparatus is further configured to condition said comparing at least one property of the processed signal frames to a noise model and a speech model upon the availability of a speech model, and if a speech model is not available, said apparatus is configured to determine whether a processed signal frame contains speech or noise dependent upon a comparison of the entropy of the current frame against a fixed threshold.

29. An apparatus in accordance with claim 23 further configured to whiten a spectrum of the current frame in accordance with a noise spectral model prior to said comparing at least one property of the processed signal frames to a noise model and a speech model.

30. An apparatus in accordance with claim 29 further configured to analyze the signal frames to update the noise spectral model.

31. An apparatus in accordance with claim 23 wherein to process the signal frames, said apparatus is configured to perform a fast Fourier transform.

32. An apparatus in accordance with claim 23 wherein to process the signal frames, said apparatus is configured to perform a wavelet decomposition.

33. An apparatus in accordance with claim 23 further comprising a speech recognition system, and wherein said apparatus is configured to utilize said signal indicative of the speech or noise determination to distinguish between speech utterances that are to be ignored from those that are to be translated into text by the speech recognition system.

34. An apparatus for detecting speech end points in an input signal containing speech portions and non-speech (noise) portions, said apparatus configured to:
analyze signal frames of the input signal to generate a noise model if no noise model exists;
when a noise model exists, determine, frame by frame, whether a frame contains speech or noise and generate a signal indicative of whether the frame contains speech or noise; and
when a specified number of consecutive speech frame determinations have been made, reset a speech model and the noise model dependent upon a comparison of an inter-frame correlation property with at least one selected criterion.

35. An apparatus in accordance with claim 34 wherein said at least one selected criterion comprises zero crossings of the inter-frame correlation.

36. An apparatus in accordance with claim 34 further configured, when a noise model exists, to update, frame by frame, either the speech model or the noise model, depending upon whether a frame has been determined to contain speech or noise, respectively.

37. An apparatus in accordance with claim 36 wherein said speech model comprises a speech entropy model and wherein said noise model comprises a noise entropy model.

38. An apparatus in accordance with claim 37 wherein said noise model further comprises a noise spectral model.

39. An apparatus in accordance with claim 38 wherein said at least one selected criterion comprises zero crossings of the inter-frame correlation.

40. An apparatus in accordance with claim 34 wherein to determine, frame by frame, whether a frame contains speech or noise, said apparatus is further configured to: determine, frame by frame, whether a sound level is exceeded and to either track a speaker according to a speaker tracking criterion or apply an energy activation criterion in accordance with said determination of whether a sound level is exceeded, and to produce a first gating decision utilizing said tracking or said applying an energy activation criterion.

41. An apparatus in accordance with claim 40 further configured to determine, frame by frame, whether a speech model is available, to apply either a Bayesian rule decision utilizing a noise entropy model and a speech entropy model or a fixed threshold decision in accordance with said determination of whether a speech model is available, and to produce a second gating decision utilizing said Bayesian rule decision or said fixed threshold decision.

42. An apparatus in accordance with claim 41 wherein said apparatus is configured to determine, frame by frame, whether a frame contains speech or noise only when both said first gating decision and said second gating decision are indicative of speech being present.

43. An apparatus in accordance with claim 34 wherein to determine, frame by frame, whether a speech model is available, said apparatus is further configured to apply either a Bayesian rule decision utilizing a noise entropy model and a speech entropy model or a fixed threshold decision in accordance with said determination of whether a speech model is available, and to produce a gating decision utilizing said Bayesian rule decision or said fixed threshold decision.

44. An apparatus in accordance with claim 34 further comprising a speech recognition system, wherein said apparatus is further configured to utilize said signal indicative of whether a frame contains speech or noise to distinguish between speech utterances that are to be ignored from those that are to be translated into text by the speech recognition system.

45. A machine readable medium having recorded thereon instructions configured to instruct a processor to detect speech end points in an input signal containing speech portions and non-speech (noise) portions, said instructions configured to instruct the processor to:
process signal frames of a digital input signal containing speech and non-speech portions to extract features therefrom;
compare at least one property of the processed signal frames to a noise model and a speech model to determine whether a processed signal frame contains speech or noise;
generate a signal indicative of the speech or noise determination; and
update either the speech model or the noise model depending upon whether a processed signal frame is determined to contain speech or noise, respectively.

46. A medium in accordance with claim 45 wherein said machine readable instructions are further configured to instruct the processor to:
determine when the comparisons indicate that a selected number of consecutive speech-containing frames have occurred;
determine an inter-frame correlation of the current frame with another previously received frame of the consecutively indicated speech-containing frames; and
reset the speech and noise models dependent upon whether a number of zero crossings in the determined inter-frame correlation is greater than a threshold number.

47. A medium in accordance with claim 45 wherein said machine readable instructions are further configured to instruct the processor, for a current frame immediately following a determination that the immediately previous frame contained noise, to:
compare a signal level of the current frame to one or more sound level thresholds; and
gate said signal indicative of said speech or noise determination upon said signal to sound level threshold comparison.

48. A medium in accordance with claim 45 wherein said noise model is a noise entropy model, and said speech model is a speech entropy model.

49. A medium in accordance with claim 48 wherein said instructions are further configured to instruct the processor to analyze signal frames to update the noise entropy model and the speech entropy model.

50. A medium in accordance with claim 45 wherein said at least one property of the processed signal frame is entropy of the processed signal frame, and wherein said instructions are further configured to instruct the processor to condition said comparing at least one property of the processed signal frames to a noise model and a speech model upon the availability of a speech model, and if a speech model is not available, said instructions are further configured to instruct the processor to determine whether a processed signal frame contains speech or noise dependent upon a comparison of the entropy of the current frame against a fixed threshold.

51. A medium in accordance with claim 45 wherein said instructions are further configured to instruct the processor to whiten a spectrum of the current frame in accordance with a noise spectral model prior to said comparing at least one property of the processed signal frames to a noise model and a speech model.

52. A medium in accordance with claim 51 wherein said instructions are further configured to instruct the processor to analyze the signal frames to update the noise spectral model.

53. A medium in accordance with claim 45 wherein to instruct the processor to process the signal frames, said instructions are configured to instruct the processor to perform a fast Fourier transform.

54. A medium in accordance with claim 45 wherein to instruct the processor to process the signal frames, said instructions are configured to instruct the processor to perform a wavelet decomposition.

55. A medium in accordance with claim 45 wherein said instructions are configured to instruct a speech recognition system to utilize said signal indicative of the speech or noise determination to distinguish between speech utterances that are to be ignored from those that are to be translated into text by the speech recognition system.

56. A machine readable medium having recorded thereon instructions configured to instruct a processor to detect speech end points in an input signal containing speech portions and non-speech (noise) portions, said instructions configured to instruct the processor to:
analyze signal frames of the input signal to generate a noise model if no noise model exists;
when a noise model exists, determine, frame by frame, whether a frame contains speech or noise and generate a signal indicative of whether the frame contains speech or noise; and
when a specified number of consecutive speech frame determinations have been made, reset a speech model and the noise model dependent upon a comparison of an inter-frame correlation property with at least one selected criterion.

57. A medium in accordance with claim 56 wherein said at least one selected criterion comprises zero crossings of the inter-frame correlation.

58. A medium in accordance with claim 56 wherein said instructions are further configured to instruct the processor, when a noise model exists, to update, frame by frame, either the speech model or the noise model, depending upon whether a frame has been determined to contain speech or noise, respectively.

59. A medium in accordance with claim 58 wherein said speech model comprises a speech entropy model and wherein said noise model comprises a noise entropy model.

60. A medium in accordance with claim 59 wherein said noise model further comprises a noise spectral model.

61. A medium in accordance with claim 60 wherein said at least one selected criterion comprises zero crossings of the inter-frame correlation.

62. A medium in accordance with claim 56 wherein to instruct the processor to determine, frame by frame, whether a frame contains speech or noise, said instructions are further configured to instruct the processor to:
determine, frame by frame, whether a sound level is exceeded and to either track a speaker according to a speaker tracking criterion or apply an energy activation criterion in accordance with said determination of whether a sound level is exceeded, and to produce a first gating decision utilizing said tracking or said applying an energy activation criterion.

63. A medium in accordance with claim 62 wherein said instructions are further configured to instruct the processor to determine, frame by frame, whether a speech model is available, to apply either a Bayesian rule decision utilizing a noise entropy model and a speech entropy model or a fixed threshold decision in accordance with said determination of whether a speech model is available, and to produce a second gating decision utilizing said Bayesian rule decision or said fixed threshold decision.

64. A medium in accordance with claim 63 wherein said instructions are configured to instruct the processor to determine, frame by frame, whether a frame contains speech or noise only when both said first gating decision and said second gating decision are indicative of speech being present.

65. A medium in accordance with claim 56 wherein to determine, frame by frame, whether a speech model is available, said instructions are further configured to instruct the processor to apply either a Bayesian rule decision utilizing a noise entropy model and a speech entropy model or a fixed threshold decision in accordance with said determination of whether a speech model is available, and to produce a gating decision utilizing said Bayesian rule decision or said fixed threshold decision.

66. A medium in accordance with claim 56 wherein said instructions are further configured to instruct the processor to utilize said signal indicative of whether a frame contains speech or noise to distinguish between speech utterances that are to be ignored from those that are to be translated into text by the speech recognition system.
